(19) United States
(12) Patent Application Publication
(10) Pub. No.: US 2003/0224222 A1
(43) Pub. Date: Dec. 4, 2003

(54) Aromatic polysulfone resin and use thereof

(75) Inventors: Yoshiki Matsuoka, Tsukuba-shi (JP); Kunihisa Satoh, Toyonaka-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/430,185

(22) Filed: May 7, 2003

(30) Foreign Application Priority Data
May 9, 2002 (JP) 2002-133799
Jun. 27, 2002 (JP) 2002-187926

(51) Int. Cl. B32B 9/04

(52) U.S. Cl. 428/704

(57) ABSTRACT

The present invention provides an aromatic polysulfone resin comprising a structural unit of the formula (I)

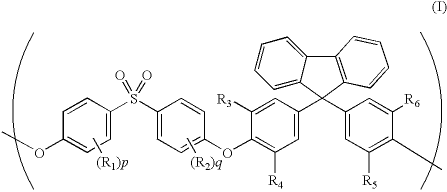

wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,

and a structural unit of the formula (II)

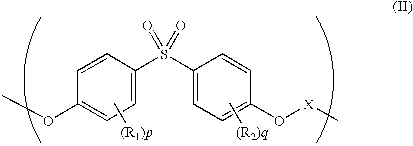

wherein R₁, R₂, p and q have the same meanings as described above, and X represents divalent group derived from alicyclic bisphenol.

The present invention also provides a solution composition containing said resin, an enameled wire obtained by using said composition and a film obtained from said composition.

### BACKGROUND OF THE INVENTION

1. Field of the Invention

The present invention relates to an aromatic polysulfone resin, a solution composition containing said resin, an enameled wire obtained by using said composition and a film obtained from said composition.

2. Prior Art

A conventional aromatic polysulfone resin film obtained from 4,4′-dichlorodiphenylsulfone and bisphenol A is film excellent in chemical resistance, flame retardancy and the like. It causes, however, problems such as lowering of the transparency of a film and occurrence of deformation, in solder reflowing. Further, it also has a problem that application of such aromatic polysulfone resin film to electronics field is limited because it has dielectric constant (ε) of 3.3 or more and signal transmission speed decreases when used for circuit board.

For solving such problems, JP-A-S63-120732 proposes cast films obtained from an aromatic polysulfone resin containing a structural unit derived from bisphenol fluorenes, and it discloses that the films are excellent in transparency and also excellent in dielectric property because of low dielectric constant. However, the films have a problem that handling is difficult for its inferior mechanical properties.

An object of the present invention is to provide an aromatic polysulfone resin capable of providing film excellent in transparency and dielectric property, further, also excelent in mechanical properties.

Other object of the present invention is to provide an aromatic polysulfone resin film having said properties.

### SUMMARY OF THE INVENTION

The present inventors have found that an aromatic polysulfone resin containing a structural unit derived from bisphenolfluorenes and a structural unit derived from alicyclic bisphenols provides a film excellent in transparency and dielectric property, further, also excellent in mechanical properties.

Namely, the present invention provides the following inventions.

<1> An aromatic polysulfone resin comprising a structural unit of the following formula (I) and a structural unit of the following formula (II).

A structural unit of the formula (I)

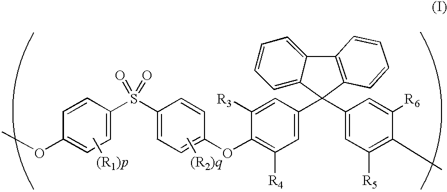

wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4

A structural unit of the following formula (II)

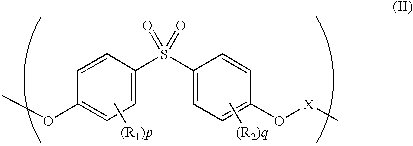

wherein R₁,R₂, p and q have the same meanings as described above, and X represents divalent group derived from alicyclic bisphenol

<2> The aromatic polysulfone resin according to <1> wherein the alicyclic bisphenol is at least one kind selected from the group consisting of 1,1,3-trimethyl-3-(4-hydroxyphenyl)-indane-5-ol, 3,3,3′,3′-tetramethyl-1′-spirobi[indane]-6,6′-diol, 1,3-dimethyl-1,3-(4-hydroxyphenyl)cyclohexane and 4,4′-[1-methyl-4-(1-methylethyl)-1,3-cyclohexanediyl]bisphenol.

<3> The aromatic polysulfone resin according to <1> or <2> wherein reduced viscosity of the aromatic polysulfone resin is from 50 to 100 cm³/g.

<4> A solution composition comprising the aromatic polysulfone resin of the formula (I), the structural unit of the formula (II) and a solvent.

<5> The solution composition according to <4> wherein the content of the aromatic polysulfone resin is 10 to 50 parts by weight in 100 parts by weight of the solution composition.

<6> The solution composition according to <4> or <5> wherein the solvent is at least one kind selected from the group consisting of an amide-based solvent and a ketone-based solvent.

<7> A film comprising the aromatic polysulfone resin comprising the structural unit of the formula (I) and the structural unit of the formula (II).

<8> The film according to <7> which is obtained by casting a solution composition comprising the aromatic polysulfone resin and a solvent and removing the solvent.

<9> An enameled wire comprising a conductor and the aromatic polysulfone resin coating thereon which comprses the structural unit of the formula (I) and the structural unit of the formula (II).

<10> The enameled wire according to <9> which is obtained by applying a solution composition comprising the aromatic polysulfone resin and a solvent on the conductor, and baking the solution composition applied conductor.

<11> A plastic substrate comprising first layer which comprises the aromatic polysulfone resin which comprses the structural unit of the formula (I) and the structural unit of the formula (II); and second layer which comprises a material having lower glass transition temperature than that of the first layer and optically transparent and is laminated on the first layer.

### DETAILED DESCRIPTION OF PREFERRED EMBODIMENTS

The present invention will be illustrated in detail.

The present resin comprises a structural unit of the above-mentioned formula (I) and a structural unit of the above-mentioned formula (II), and the present resin has Tg of 260° C. or more and dielectric constant of 3.0 or less. The film obtained from the present resin has excellent properties in transparency, in heat resistance, and in mechanical properties. Further, the film has the excellent properties having low percentage of water absorption (i.e. high barrier property against water vapor), having low dielectric constant at a high frequency band, small dielectric loss at a high frequency band, a low percentage of water absorption (i.e., high barrier property against water vapor), as well as excellent mechanical strength.

The film obtained by molding aromatic polysulfone resin containing a structural unit derived from bisphenol fluorenes but not containing a structural unit derived from alicyclic bisphenols shows so inferior mechanical properties that it is fragile and easily broken.

In the formula (I), R₁ and R₂ each independently represents halogen, alkyl having 1 to 6 carbon atoms, alkenyl having 2 to 10 carbon atoms or phenyl. R₃, R₄, R₅ and R₆ each independently represents hydrogen, methyl, ethyl or phenyl, preferably hydrogen.

p and q each independently represents an integer of 0 to 4, and both of p and q is preferably 0.

In the formula (I), examples of halogen include fluorine, chlorine, bromine and iodine. Examples of alkyl having 1 to 6 carbon atoms include methyl, ethyl, t-butyl and cyclohexyl. Examples of alkenyl having 2 to 10 carbon atoms include ethynyl and iso-propenyl.

In the formula (II), X represents divalent group derived from alicyclic bisphenol. The divalent group can be expressed by the alicyclic bisphenol structure in which each of the two hydroxyl groups is substituted with single bond.

Examples of the alicyclic bisphenol include

4-[1-[4-(hydroxyphenyl)-1-methylcyclohexyl]-1-methylethyl]phenol of the formula (1),

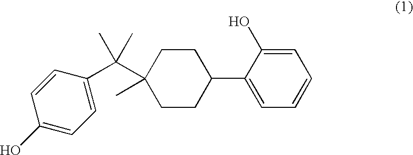

4-[1-[3-(4-hydroxyphenyl)-4-methylcyclohexyl]-1-methylethyl]phenol of the formula (2),

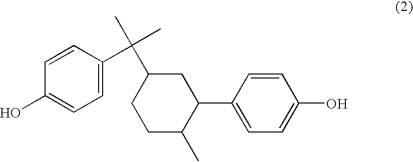

4,4′-[1-methyl-4-(1-methylethyl)-1,3-cyclohexanediyl]bisphenol of the formula (3),

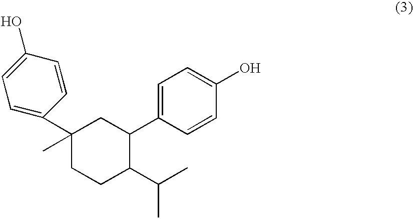

1,3-dimethyl-1,3-(4-hydroxyphenyl)cyclohexane of the formula (4),

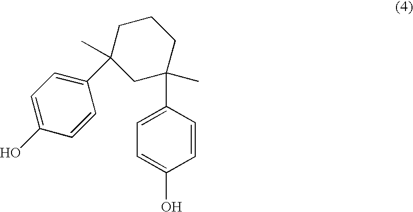

1,6-diazaspiro[4.4]nonane-2,7-dione, 1,6-bis(4-hydroxyphenyl),

dicyclopentadienylbisphenol, 2,5-norbornadienylbisphenol,

1,3-bis(4-hydroxyphenyl)adamantane,

1,3-bis(4-hydroxyphenyl)-5,7-dimethyladamantane,

4,9-bis(4-hydroxyphenyl)diadamantane,

1,6-bis(4-hydroxyphenyl)diadamantane,

6,6-dihydroxy-4,4,4′,4′,7,7′-hexamethyl-1,2,2-spiro-bischroman,

3,6-dihydroxy-9,9-dimethylxanthene,

1,1,3-trimethyl-3-(4-hydroxyphenyl)indane-5-ol of the formula (5),

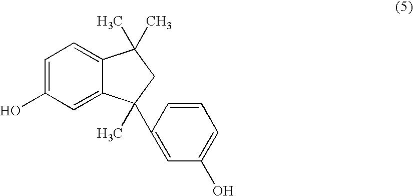

3,3,3′,3′-tetramethyl-1,1′-spirobi[indane]-6,6′-diol of the formula (6),

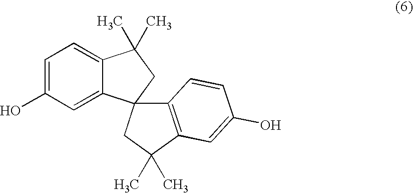

4,4′-cyclohexylidenebisphenol, 4,4′-(4-methylcyclohexylidene)bisphenol,

4,4′-(4-ethylcyclohexylidene)bisphenol,

4,4′-(4-isopropylcyclohexylidene)bisphenol,

4,4′-(4-t-butylcyclohexylidene)bisphenol, 4,4′-(cyclododecylidene)bisphenol,

4,4′-(cyclopentylidene)bisphenol, 4,4′-(3,3,5-trimethylcyclohexyl)bisphenol,

4,4′-[3-(1,1-dimethylethyl)cyclohexyl]bisphenol,

4,4′-(cyclohexylidene)bis[2-cyclohexylphenol],

5,5′-(1,1-cyclohexylidene)bis[1,1′-(biphenyl)-2-ol],

2,2-bis(4-hydroxyphenyl)norbornene,

8,8-bis(4-hydroxyphenyl)tricyclo[5.2.1.0^{2,6}]decane,

2,2-bis(4-hydroxyphenyl)adamantane,

4,4′-(methylidene)bis[2-cyclohexylphenol] and the like.

Preferred examples thereof are

1,1,3-trimethyl-3-(4-hydroxyphenyl)indane-5-ol,

3,3,3′,3′-tetramethyl-1,1′-spirobi[indane]-6,6′-diol,

1,3-dimethyl-1,3-(4-hydroxyphenyl)cyclohexane and

4,4′-[1-methyl-4-(1-methylethyl)-1,3 cyclohexanediyl]bisphenol.

The present resin may be random copolymer, alternating copolymer or block copolymer as long as structural unit of the formula (I) and structural unit of the formula (II) are contained.

As the present resin, resins containing repeating structural units of the following can be specifically listed.

The present resin may further contain at least one structural unit selected from the group consisting of the structural units of the following formulae (III), (IV) and (V) in addition to the structural unit of the formula (I) and the structural unit of the formula (II).

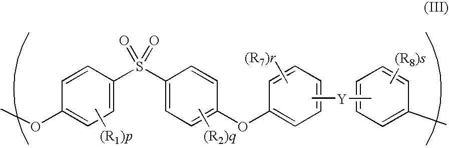

In the formula (III), R₁, R₂ p and q have the same meanings as described above.

R₇ and R₈ each independently represent halogen, phenyl, alkyl having 1 to 6 carbon atoms or alkenyl having 2 to 10 carbon atoms, and r and s represent an integer of 0 to 4, preferably 0.

Y represents —S—, —O—, —CO— or divalent aliphatic hydrocarbon group having 1 to 20 carbon atoms. At least one hydrogen atom in the divalent aliphatic hydrocarbon group may be substituted by fluorine. Examples of the divalent aliphatic hydrocarbon group include alkylene groups such as isopropylidene group, ethylidene group, methylene group and the like; perfluoroalkylidene groups such as hexafluoroisopropylidene group and the like, alkynylidene groups such as ethynylene group and the like.

The structural unit of the formula (III) can be prepared by reacting dihalogenodiphenylsulfones and alkali metal salt of corresponding bisphenols.

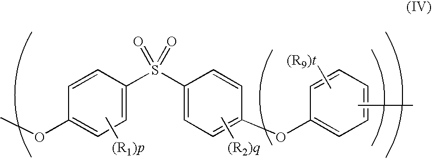

In the formula (IV), R₁, R₂, p and q have the same meanings as described above.

R₉ represents halogen, phenyl, alkyl having 1 to 6 carbon atoms or alkenyl having 2 to 10 carbon atoms, and t represents an integer of 0 to 4, preferably 0.

In the formula (IV), a represents an integer of 1 to 5, preferably 1 or 2, more preferably 2.

The structural unit of the formula (IV) can be prepared by reacting dihalogenodiphenylsulfones and alkali metal salt of corresponding dihydroxybenzenes such as hydroquinone.

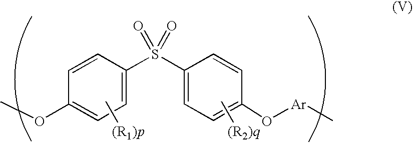

In the formula (V), R₁, R₂, p and p have the same meanings as described above.

Ar represents aromatic hydrocarbon group with the exception of the following formula (7), at least one hydrogen in the aromatic hydrocarbon group may be substituted by alkyl having 1 to 6 carbon atoms.

The structural unit of the formula (V) can be prepared by reacting dihalogenodiphenylsulfones and alkali metal salt of corresponding bisphenols.

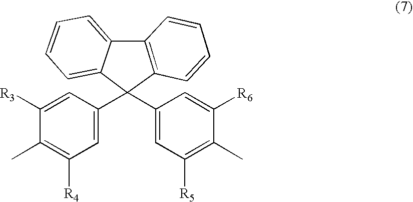

In the formula (7), R₃ to R₆ have the same meanings described above.

Examples of the aromatic hydrocarbon group include arylalkylene such as (pentaphene)(phenyl)methylene, (pentaphenephenyl)methylene, and the like, pentalenediyl, indenediyl, naphthalenediyl, azulenediyl, heptalenediyl, as-indacenediyl, s-indacenediyl, acenaphthylenediyl, fluoranthenediyl, acephenanthrylenediyl, aceanthrylenediyl, triphenylenediyl, pyrenediyl, chrysenediyl, naphthacenediyl, picenediyl, xylenediyl, biphenylene and the like.

The molar ratio of the structural unit of the formula (I) to the total mole of structural units of the formula (I) and the formula (II), which is hereinafter abbreviated to “I/I+II”, is usually 0.1 to 1, preferably 0.5 to 0.9.

When at least one structural unit selected from the group consisting of the formula (III), formula (IV) and formula (V) is contained, the molar ratio of the structural unit of the formula (I) to the total mole of structural units of the formula (I), the formula (II), the formula (III), the formula (IV) and the formula (V), which is hereinafter abbreviated to “I/I+II+III+IV+V”, is usually 0.1 to 1, preferably 0.5 to 0.9.

The reduced viscosity of the present resin is preferably from 50 to 100 cm³/g, more preferably from 50 to 80 cm³/g, further preferably from 50 to 75 cm³/g. When the present resin having the reduced viscosity of 50 cm³/g or more is applied for the enameled wire, the resulted covering layer obtained from the resin has higher mechanical strength, consequently, leading to better handling. When the present resin having the reduced viscosity of 100 cm³/g or less is applied for film, it is easy to prepare uniform solution and filtration and de-foaming thereof can be easily performed, and appearance of the film becomes better.

The reduced viscosity herein means a value obtained by dissolving 1 g of an aromatic polysulfone in 100 cm³ of N,N-dimethylformamide, then, measuring the viscosity of this solution using Ostwald viscosity tube at 25° C.

The method of producing the present resin is not particularly restricted, and exemplified are a method in which mixture of alkali metal salt of 9,9-bis(4-hydroxyphenyl)fluorene, alkali metal salt of alicyclic bisphenol and dihalogenodiphenylsulfone and if necessary alkali metal salt of other bisphenol are heated in a suitable polymerization solvent to cause polymerization, and the like.

As the alkali metal salt, sodium salts, potassium salts and the like can be listed. Said alkali metal salt can be produced by reacting one molar number of alkali metal hydroxide (for example, sodium hydroxide, potassium hydroxide and the like) and the equimolar number of hydroxide group in total of 9,9-bis(4-hydroxyphenyl)fluorenes and alicyclic bisphenols and if necessary other bisphenol in a suitable solvent.

The dihalogenodiphenylsulfone is a compound represented by the following formula (8)

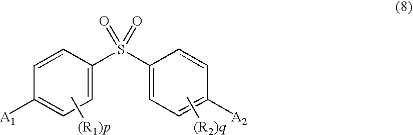

wherein R1, R2, p and q have the same meanings as described above. Specific examples thereof include 4,4′-dichlorodiphenylsulfone, 4,4′-difluorodiphenylsulfone and the like.

Examples of the solvent for the polymerization reaction include amide-based polar solvents such as N-methylpyrrolidone, N-dichlorohexylpyrrolidone, dimethylformamide, dimethylacetamide and the like; sulfone-based polar solvents such as sulfolane, dimethylsulfone and the like; sulfoxide-based polar solvents such as dimethylsulfoxide, diethylsulfoxide and the like. Among them, amide-based polar solvents are preferred, and N,N-dimethylacetamide is particularly preferred because of its excellent polymer solubility.

The present resin can be produced also by reacting 9,9-bis(4-hydroxyphenyl)fluorenes, alicyclic bisphenol, dihalogenodiphenylsulfone and alkali metal carbonate and if necessary other bisphenol in a suitable polymerization solvent.

Here, as the alkali metal carbonate, for example, sodium carbonate, potassium carbonate, and the like are listed. The alkali metal carbonate is preferably anhydrous. For completion of the polymerization reaction and prevention of decomposition of the resulted polymer and the polymerization solvent, the alkali metal carbonate is added preferably in an amount of 1 to 1.5 moles based on one mole in total of 9,9-bis(4-hydroxyphenyl)fluorene and alicyclic bisphenol and if necessary other bisphenol.

It is preferable to use the dihalogenodiphenylsulfone of substantially the same mol number as the total mol number of 9,9-bis(4-hydroxyphenyl)fluorenes and alicyclic bisphenols and if necessary other bisphenol. When the dihalogenodiphenylsulfone is excess or deficient, a tendency arises that resulted resin with higher polymerization degree can not be obtained.

As the polymerization solvent, the same solvents as the above-mentioned polymerization solvents are listed.

The above-mentioned reaction using alkali metal carbonate is believed to progress sequentially in two stages. In the first stage, an alkali metal salt of 9,9-bis(4-hydroxyphenyl)fluorenes and an alkali metal salt of alicyclic bisphenols and if necessary alkali metal salt of other bisphenol are produced, subsequently, in the second stage, a polycondensation reaction of these alkali metal salts and dihalogenodiphenylsulfone progress. Since the reaction in the first stage is an equilibration reaction with dehydration, this reaction can be progressed more advantageously by taking by-produced water out of the system. For this purpose, it is preferable to allow an organic solvent causing azeotropy with water to co-exist and to remove by-produced water. As the organic solvent causing azeotropy with water, known solvents such as, for example, benzene, chlorobenzene, toluene and the like are listed. In the first stage of this reaction, reaction is continued until water does not perform azeotropy, at temperatures at which an azeotropic solvent and water manifest azeotropy, namely, at temperatures from 70° C. to 200° C. Subsequently in the second stage, a polymerization reaction is conducted at higher temperatures. Though the polymerization reaction progresses more advantageously when the reaction temperature is higher, it is preferable that the polymerization reaction is conducted substantially at the reflux temperature of a polymerization solvent.

When the molecular weitht of the polymer obtained becomes intended value, the reaction is stopped. Stop of the reaction can be performed by lowering the temperature or by adding alkyl halide (RA₃) such as methyl chloride to inactivate unreacted phenolate terminal of the polymer. The alkyl halide can be shown by RA₃, wherein R represents lower alkyl having about 1 to 3 carbon atoms and A represents halogen such as chlorine, bromine, and the like.

A polymer after polymerization can be recovered, for example, by spray drying, re-precipitation with a poor solvent after separation by filtration or centrifugation, if necessary, however, the recovering method is not limited to these methods.

The end group of the present resin obtained by the above-mentioned methods and the like is not particularly restricted, and is usually —F, —Cl, —OH, —OR (R represents alkyl) and the like, wherein R is derived from alkyl halide shown by RA₃ described above.

Next, the aromatic polysulfone resin film will be illustrated.

The aromatic polysulfone resin film of the present invention (hereinafter referred to as “the present film”) comprises the present resin and can be produced by methods such as, for example, solution casting method, melt extrusion molding method, blow molding method, compression molding method and the like. If the surface property and condition and thickness precision of a film and thermal degradation influence are taken into consideration, its production is conducted preferably by the solution casting method.

As the solution casting method, there may be a method in which a solution composition comprising the present resin and a solvent (hereinafter referred to as “the present solution composition”) is prepared and then the the present solution composition is cast on a supporting substrate and the like (hereinafter referred to as “casting process”, in some cases) to form cast film, then, the solvent is removed from the film (hereinafter referred to as “solvent removal process”, in some cases) to obtain the present film.

The solvent used is not particularly restricted as long as capable of dissolving the present resin, and it is preferably a solvent containing at least one solvent selected from the group consisting of amide-based solvents and ketone-based solvents.

Specific examples of the solvent include amide-based solvents such as N,N-dimethylformamide, N,N-dimethylacetamide, N-methyl-2-pyrrolidone and the like; ketone-based solvents such as cyclohexanone, cyclopentanone and the like. Among them, N,N-dimethylacetamide, N-methyl-2-pyrrolidone and cyclohexanone are preferably used.

The present solution composition preferably contains the present resin in an amount of 10 to 50 parts by weight in 100 parts by weight of the present solution composition. When the content is 10 parts by weight or more, it is economically advantageous for its high effective concentration and there is a tendency to suppress generation of defects such as surface roughness, popping, and the like in the film during film formation. When the content is 50 parts by weight or less, the present solution composition has good filtration property, and generation of small lumps in the film therefrom may be suppressed.

Examples of the method for producing the present solution composition include a method in which the solvent is added to the resin, a method in which the resin is added to the solvent, a method in which using the solution itself obtained in the production of the resin, and the like. It is recommended to use the powder form of the resin or to heat the solution.

When the present solution composition is applied in electronics field or heavy electric field such as for enameled wires, the content of isolated chloride ion in the present solution composition is preferably 50 ppm or less, more preferably 20 ppm or less, further preferably 10 ppm or less for suppressing corrosion of leading wire. As the conductor tends to be corroded when its content of isolated chloride ion is more than 50 ppm, it is preferable to combine a deionization procedure during the production of the present solution composition.

In the present solution composition, various additives such as leveling agent, plasticizer and the like can be contained, if necessary.

Examples of leveling agent include for example, acrylic polymers or oligomers, silicone polymers or oligomers, fluorine polymers or oligomers.

Plasticizers are preferably those that are compatible with the present resin, do not cause phase separation or bleeding out, and do not cause coloring. Examples thereof include plasticizers such as phthalic, phosphoric, adipic, citric, glycolic plasticizers. Among these, butylbenzyl phthalate, tricresyl phosphate, methylphthalylethyl glycolate and the like are preferably used.

The present solution composition is cast on a supporting substrate and the like to form cast film containing a solvent (casting process). In this process, it is general that the present solution composition is cast on a substrate such as an endless band or drum and the like using a comma coater, lip coater, doctor blade coater, bar coater, roll coater and the like.

As viscosity lowers and coating of the present solution composition having higher solid content becomes possible as well as the stability of the solution increase, it is preferable that the present solution composition is maintained at temperatures of 50° C. or more in casting.

The substrate is not particularly restricted, and it is preferable to use metal such as stainless on which mirror surface treatment has been performed, resin film such as polyethylene terephthalate film and the like, glass, and the like.

The solvent is removed from thus formed cast film, to form the present film (solvent removal process). As the method of removing solvent, for example, a method of evaporating solvent to dry, and the like are listed. Evaporation of solvent is preferably conducted by heating for improving the efficiency of evaporation. Though heating may be conducted at constant temperature, it is more preferable to change the heating temperature over several stages or more from the standpoints of economy and smoothness of the surface of the film obtained. For reducing the remaining solvent amount, heating under reduced pressure is further preferable.

For efficiently producing the present film having substantially the same glass transition temperature as the glass transition temperature of the present resin itself, it is preferable, after the solvent removal process, to conduct post workings such as heat treatment, stretching, rolling and the like at temperatures of the glass transition temperature of the present resin or higher. Particularly when heat treatment is performed, it is preferable to conduct heating at temperatures of 280° C. or more and 500° C. or less.

The remaining solvent content in the present film after removal of solvent is preferably 5% by weight or less, more preferably 1% by weight or less, further preferably 0.5% by weight or less. When the remaining solvent amount is 5% by weight or less, drop of the glass transition temperature of aromatic polysulfone resin film is prevented, and in the case of application of beat in the post working, tendency of dimension change and curling, and occurrence of moisture absorption is prevented. Further, a tendency that the remaining solvent exerts a reverse influence on members around the film in a practical stage can be also prevented.

The present film formed is usually used after peeled from a substrate. Examples of the peeling method include a method in which continuous peeling from substrate is effected for obtaining long film, a method in which peeling is conducted in batch-wise mode using substrate in the form of sheet for obtaining short film, and the like.

A plurality of the resulted films may be laminated for use. As the laminating method, for example, adhesion by various methods, and the like are listed. As the adhesion method, a method of adhesion using a good solvent for the film, a method of adhesion using adhesive, and the like are listed.

The present film thus produced can be suitably used in, for example, H class electric appliances, slot liners of motors and generators, insulation materials for inter-laminar insulation, wrapping materials for wires and transformers processed in the form of tape by coating an adhesive, dielectric films or insulation materials in the form of tube for plastic film condenser, and the like, in electric insulation field; flexible print circuit boards and its reinforcing boards, heat resistant spacers, PCB laminates, and the like, in electronics-related field; vibration plates and vibration reinforcing plates of speakers, in audio-related field; recording tapes and disks for which dimension stability is required, plastic substrate substituted for glass substrate used for displays such as liquid crystal displays, EL displays, electronic paper, retardation films obtained by stretching treatment, connecting portions of optical fibers, and the like, in information-related field, and heating packs for medical sterilization apparatus, electronic ovens and oven-ranges, and the like, in food and medical field.

The form of the present film used as a dielectric film is explained in more detail.

The present film used as a dielectric film is preferably the one obtained by solution cast method, because line such as die line is not generated, thickness uniformity of the film is very accurate, and properties in MD diretion and in TD direction are almost the same.

The thickness of the present film used as the dielectric film for compact and high-efficient plastic film condenser is preferably 25 μm or less, more preferably 10 μm or less, further preferably 5 μm or less.

The level of the thickness uniformity is preferably within ±10% of average thickness of the present film, more preferably within ±5%. If the level is more than ±10%, impotant characteristics such as electrostatic capacity, dielectric strength, dielectric constant, and the like tends to vary in wide range as well as to be difficult to be compact.

The level of the thickness uniformity of film can be calculated by the following.

The dielectric constant at 1 kHz of the present film used as the dielectric film is preferably 3.0 or less, more preferably 2.7 or less. When the dielectric constant is more than 3.0, signal transmission speed of the film tends to drop.

A plastic film condenser can be obtained by winding method in which the present film used as the dielectric film and metal film are wound alternatively, then melted metal is sprayed on one surface of the metal film to set up electrode, a method in which metal deposited the present film used as dielectric film is wound, then melted metal is sprayed on one surface of the deposit to set us electrode.

Examples of the metal used for the metal film include aluminum, zinc, tin, titanium, nickel, and alloy thereof. Among them, aluminum is preferred. The thickness of the metal film is usually 200 to 3000 Å, and preferably 400 to 2000 Å. Size and shape of the metal film is not restricted and is suitably selected depending on its purpose.

Examples of the metal deposited include the same metals as the metal used for metal film described above.

The plastic film condenser thus obtained is preferably used for compact electronic appatus with high performance as it is excellent in heat resistance and has low dielectric constant.

Next, the form of the present film used as plastic substrate is explained in more detail.

The plastic substrate is obtained by using the present film as base film, if necessary, further laminating smooth layer, hard coat layer, gas barrier layer, transparent conductive layer and the like on this.

The base film may be the present film alone, alternatively, a lamination film formed by laminating first layer comprising the present film on second layer comprising a material having lower glass transition temperature than that of the first layer and optically transparent, further, a lamination film formed by laminating the first layer, the second layer and a third layer composed of the present film in this order.

A case of using lamination film as a base film will be illustrated.

The first layer composed of the present film is laminated on one surface or both surfaces of the second layer having lower glass transition temperature than that of the first layer. The lamination film obtained by laminating the first layer on one surface or both surfaces of the second layer has an excellent ability that heat deformation generating in heating at high temperature can be prevented as compared with the case of the second layer alone. The film thickness of the first layer preferably occupies 20 to 80% of the lamination film though varying depending on the film thickness of the whole lamination film and heat resistant shape stability required.

When said lamination film is used in various displays such as liquid crystal displays and the like, it is required that the lamination film has low retardation. The value of retardation is preferably 50 nm or less, more preferably 20 nm or less though varying depending also on the kind of a display.

When a phase difference function is imparted to the lamination film, at least one of layers laminated can be endowed previously with required retardation, then, a phase difference function can be imparted easily by lamination. In this case, the value of retardation is preferably 100 nm or more, more preferably 300 nm or more. Particularly impartment of retardation to a material forming the first layer and manifesting the highest heat resistance is preferable from the standpoint of heat stability of the resulted phase difference film.

Retardation is determined by the thickness of film and the degree of orientation of a polymer chain, and the orientation of a polymer chain is significantly influenced by stretching conditions, therefore, for imparting required retardation to the first layer, film derived from a material having highest heat resistance described above is preferably stretched mono-axially or bi-axially. For controlling retardation value strictly, it is preferable that the thickness of the first layer is relatively thin. Therefore, the thickness of the first layer is preferably from 10 to 150 μm, more preferably from 20 to 100 μm.

The film before stretching can be obtained by a known film formation technology, and it is particularly preferable to use a film produced by cast method from the standpoints of thickness precision, surface smoothness, optical property and the like.

As the material used as the second layer, materials having small birefringence, easily providing thicker film formation, further, having lower heat resistance than that of the first layer, are preferably used.

The glass transition temperature of the material constituting the second layer depends on the extent of heat resistance required, and preferably 100° C. or more, more preferably 140° C. or more. Further, the glass transition temperature of the material constituting the second layer is preferably lower by 20° C. or more, more preferably lower by 40° C. or more, than the lowest glass transition temperature of materials constituting the first layer.

When heat fusion is conducted in lamination process, the second layer is heated to its glass transition temperature or more, therefore, optical initial property thereof is significantly alleviated. For this reason, material having large birefringence can be used in the second layer.

Examples of such materials used in the second layer include polyesters, polyarylates, polycarbonates, polysulfones, polyamides, polyether imides and the like, and these may be used alone or in combination of two or more. Among them, the polysulfone is particularly preferable as the material in the second layer since it shows high affinity with the first layer. The second layer may be composed of a single layer or a plurality of layers.

The second layer mainly imparts mechanical strengths such as rigidity and the like to the whole lamination film, therefore, materials constituting the second layer are required to have mechanical strength in addition to excellent adhesion with the first layer. Even if the lamination film is heated to temperatures of not lower than the glass transition temperature of the second layer, the film is protected by the first layer having high glass transition temperature present on one surface or both surfaces thereof, and the original form can be maintained without flowing and deformation. The thickness of the second layer is determined also depending on properties required for the lamination film, and it is preferable it occupies 80 to 20% of the thickness of the whole lamination film.

The above-mentioned lamination film can be easily produced by a method in which resins constituting respective layers are melt co-extruded, a method in which each layer is produced singly by melt extrusion or cast, then, laminated, a method in which layers are laminated using adhesive, and the like. When adhesive is used, it is preferable to select adhesive so that the heat resistance of the lamination film is not deteriorated.

For utilization of the above-mentioned plastic substrate as a display, secondary workings such as formation of a transparent conductive layer and the like may be further performed. Further, for improving a barrier ability against oxygen, water vapor and the like, the plastic substrate may be subjected, if necessary, to organic gas barrier working with an ethylene-vinyl alcohol copolymer, polyvinylidene chloride and the like, or inorganic gas barrier working with silica, alumina and the like. The thickness of such plastic substrate is suitably from 0.1 to 5 mm, particularly preferably from 0.2 to 2 mm from the standpoint of handling in producing a display.

The plastic substrate can be used together with or exchanged for glass from the standpoints of heat resistance and optical property, and is useful as a substrate for an optoelectronics element such as a display and the like. Further, it is particularly useful as glass substrate-substituting film for a panel of displays such as liquid crystal displays, EL displays, electronic paper and the like since it can be made into thin film in addition to excellent impact resistance and light weight, compared to glass.

An enameled wire of the present invention is explained in more detail.

Enameled wires can be manufactured by for example, applying the present solution composition on a conducting wire, followed by baking to form coating layer.

Materials for the conducting wire are not particularly limited, however, copper, aluminum and the like can be exemplified.

The temperature for baking is usually from 100 to 500° C.

The coating layer can be provided to give a single layer composed of the present resin, or alternatively, another insulating layer may be combined to give multiple layers.

The processes for providing multiple layers include for example, a process in which another resin layer is coated over a layer composed of the present resin obtained from the present solution composition, or a process in which the present solution composition is coated by upper coating over a conducting wire that had been coated with another resin.

Examples of the another resins include polyurethane, polyester, polyesterimide, polyesteramideimide, polyamide, polyimide, polysulfone, polyethersulfone and the like.

Thickness of the coating layer is preferably 100 μm or less, and more preferably 50 μm or less. When the thickness of the coating layer is greater than 100 μm, there arises tendency to difficulty in corresponding to recent trends to downsizing of electronic equipments because of too bulky volume upon processing into a coiled form of the enameled wire, although thicker coating results in increased dielectric breakdown voltage.

Thus resulting enameled wires can be used in electronic equipments after processing into coiled forms.

Using the present solution composition enables production of an enameled wire that exhibits excellent heat resistance, small dielctric constant at high frequency band and small dielectric loss at high frequency band, a low percentage of water absorption, as well as excellent mechanical strength; coils obtained using such enameled wires; and electronic equipments obtained using such coils.

The present invention will be illustrated based on examples, however, the present invention is not limited to the examples.

[Measurement of Glass Transition Temperature of Aromatic Polysulfone Resin not Containing Solvent]

Using a heat analysis system SSC/5200 manufactured by Seiko Denshi Kogyo K.K., aromatic polysulfone resin was heated from 25° C. to 330° C. at a rate of 100° C./min. and left at the same temperature for 30 minutes to remove solvent completely. After cooling to room temperature, the resin was heated from 25° C. to 350° C. at a rate of 10° C./min. The glass transition temperature was thus measured.

[Test of Solubility of Aromatic Polysulfone Resin]

0.5 g of aromatic polysulfone resin was weighed, and dissolved in 4.5 g of a solvent to prepare 10 wt % solution. As the solvent investigated here, methylene chloride, 1,3-dioxolane, tetrahydrofuran, 1,4-dioxane, cyclohexanone, γ-butyrolactone, N,N-dimethylformamide, N,N-dimethylacetamide, N-methyl-2-pyrrolidone, dimethylsulfoxide and sulfolane were used. Each solution was left over night at room temperature, then, cloudiness and gelling in the solvent were evaluated visually. Measurement of molecular weight

[Measurement of Reduced Viscosity of Aromatic Polysulfone Resin]

For measurement of reduced viscosity, 1.0 g of aromatic polysulfone resin was dissolved in 100 ml of N,N-dimethylformamide, then, the flow velocity of the solution was measured at 25° C. using Ostwald type viscosity tube. From the resulted value, RV value was calculated using the following formula.

RV=(1/C)×(t−t₀)/t₀

Here, t represents the flow time (second) of polymer solution, t₀ represents the flow time (second) of pure solvent, and C represents the concentration of polymer in the solvent.

[Mesurement of Molecular Weight of Aromatic Polysulfone Resin by GPC Analysis]

For weight-average molecular weight, 10 mg of aromatic polysulfone resin was dissolved in 10 ml of N,N-dimethylformamide containing 0.1 mol/1000 cm³ of lithium bromide, then, the solution was analyzed using GPC apparatus HLC-8220 manufactured by Toso Corp. (column: TSKgel SuperHZM-M, column temperature: 40° C.). The resulted molecular weight was converted using standard polystyrene.

[Drying Conditions of Film]

Aromatic polysulfone resin solution was coated on a glass substrate using an applicator, then, dried under the following conditions. Previous drying was condcted under a condition of coated on a glass plate and real drying was conducted under a condition of peeled from a glass plate.

Previous drying (on hot plate)

80° C.×30 min.+1000° C.×30 min.+130° C.×30 min.

Real drying (in hot air oven)

150° C.×1.5 hours+190° C.×1.5 hours+230° C.×2 hours+250° C.×2 hours+270° C.×2 hours

[Measurement of Glass Transition Temperature of Film]

Using heat analysis apparatus EXTRA TMA6100 manufactured by Seiko Denshi Kogyo K.K., aromatic polysulfone resin film was heated from 25° C. to 300° C. at a rate of 5° C./min. while charging a load of 5 gf on the film, and the elongation of the film was measured. The inflection point of the resulted chart was assigned to Tg. Measurement was conducted under nitrogen flow.

[Measurement of Dielectric Constant of Film]

Using dielectric loss analyser TR-10C manufactured by Ando Denki K.K., the dielectric constant of film was measured. Measurement was conducted according to ASTM D150. Test environment includes 23° C.±2° C., 50±5%RH

[Measurement of Mechanical Strength of Film]

The tensile strength and elongation of film were measured according to ASTM D882, and the tearing strength of the film was measured according to JIS K7128.

### PRODUCTION EXAMPLE 1

28.72 g of bis(4-chlorophenyl)sulfone, 28.02 g of 9,9-bis(4-hydroxyphenyl)fluorene and 5.37 g of 1,1,3-trimethyl-3-(4-hydroxyphenyl)-indane-5-ol were charged into 500 mL SUS316L polymerization vessel equipped with a nitrogen inlet, paddle type stainless stirrer and condenser, then, 200 ml of N,N-dimethylacetamide and 120 ml of toluene were added and the atmosphere was purged with dry nitrogen for 30 minutes. Subsequently, this mixture was heated up to 100° C. over 1 hour in an oil bath, 14.37 g of potassium carbonate was added and azeotropic dehydration was conducted at 135° C., then, the solution was heated up to 180° C. and maintained at 180° C. for 13 hours. The viscous polymer mixture obtained here was cooled to room temperature, then, poured into methanol and re-precipitated and recovered. Further, this precipitate was washed using water, methanol and acetone, then, dried at 150° C. over night. The resulted polymer had reduced viscosity of 68 cm³/g, and weight-average molecular weight of increased to 180000. It had glass transition temperature of 276° C. When solubility test was conducted, this polymer was dissolved in cyclohexanone, N,N-dimethylacetamide, and N-methyl-2-pyrrolidone.

The aromatic polysulfone resin obtained in Production Example 1 was the resin containing the following structural units.

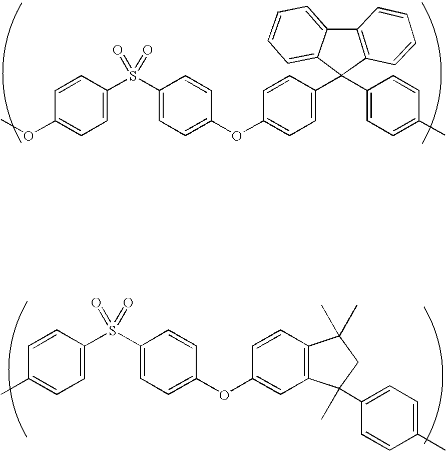

### PRODUCTION EXAMPLE 2

25.43 g of bis(4-fluorophenyl)sulfone and 35.04 g of 9,9-bis(4-hydroxyphenyl)fluorene were charged together with 354.5 g of diphenylsulfone into 500 mL SUS316L polymerization vessel equipped with a nitrogen inlet, paddle type stainless stirrer and condenser, then, the atmosphere was purged with dry nitrogen for 30 minutes. This mixture was melted at 180° C. in oil bath, then, 14.37 g of potassium carbonate was added, Subsequently, this mixture was allowed to react at 180° C. for 1 hour while purging with nitrogen, then, heated up to 230° C. over about 1.7 hours, and maintained for 6 hours at the same temperature, to obtain viscous polymerization mixture. Then, the polymerization mixture was poured into a metal tray, cooled at room temperature, to cause solidification. The polymerization mixture was ground and passed through a 1.4 mm sieve, then, washed using hot deionized water, acetone and methanol. After washing, the resulted aromatic polysulfone resin composition was dried at 150° C. over night. The resulted polymer had reduced viscosity of 41 cm³/g, and glass transition temperature of 285° C. When solubility test was conducted, this polymer was dissolved in N,N-dimethylacetamide.

The aromatic polysulfone resin obtained in Production Example 2 was the resin consisting of the following structural unit.

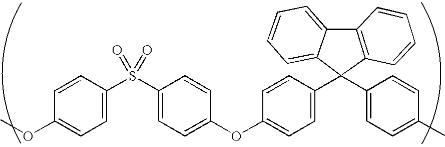

### EXAMPLE 1

23 wt % N,N-dimethylacetamide solution of the aromatic polysulfone resin having reduced viscosity of 68 cm³/g obtained in Production Example 1 was prepared. The solution was coated on a glass plate using an applicator (coating width: 150 mm) having a clearance of 200 μm and dried under the conditions described above.

The film had glass transition temperature of 270° C. and dielectric constant (@ 1 kHz) of 2.7. It showed that the film had excellent heat resistance and dielectric property. Further, the film had tensile strength of 82.4 MPa and tearing strength of 8.5 kgf/mm. It showed that it had no problem in mechanical properties. Said 23 wt % N,N-dimethylacetamide solution of the aromatic polysulfone resin remained stable more than 1 week at room temperature without cloudiness or gellation.

### COMPARATIVE EXAMPLE 1

20 wt % N,N-dimethylacetamide solution of the aromatic polysulfone resin having reduced viscosity of 41 cm³/g obtained in Production Example 2 was prepared. The solution was coated on a glass plate using an applicator (coating width: 150 mm) having a clearance of 180 μm and dried under the above-mentioned conditions. However, this film was very fragile, and was broken easily when peeled from the glass plate in a stage converting from the previous drying to the real drying.

### COMPARATIVE EXAMPLE 2

A 20% solution of Sumika Excel PES7600P (trade name, manufactured by Sumitomo Chemical Co., Ltd.; polyethersulfone, reduced viscosity of 76 cm³/g) in N,N-dimethylformamide was subjected to cast coating on a polyethylene terephthalate (PET) film using Multi test coater NCR 230 (manufactured by Yasui Seiki Co., Ltd.) equipped with a knife coater of which clearance being 200 μm. In this process, line speed employed was 0.5 ml/min, and the temperature in the drying oven was 100° C. Further, this successive film was cut out to give A4 sized films, and dried in a forced-air oven at 200° C. for 2 hours. The film was stripped off from the support to give a polyethersulfone (PES) film for evaluation. This film had Tg of 223° C., dielecric constant (@ 1 kHz) of 3.3, and transmission of water vapor of 526 (g/m²-24 hr).

The aromatic polysulfone resin used in Comparative Example 2 was the resin consisting of the following structural unit.

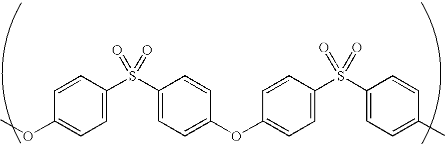

According to the present invention, aromatic polysulfone resin suitable for film with excellent in transparency and dielectric property, further, also excellent in mechanical ability, can be provided. The solution composition comprising said resin and solvent is suitable for producing said film. Enameled wire in which conductor is coated by the resin exhibits small dielctric constant at high frequency band and small dielectric loss at high frequency band, a low percentage of water absorption, as well as excellent in heat resistance, in transparency and in mechanical strength.

What is claimed is:

1. An aromatic polysulfone resin comprising a structural unit of the formula (I) 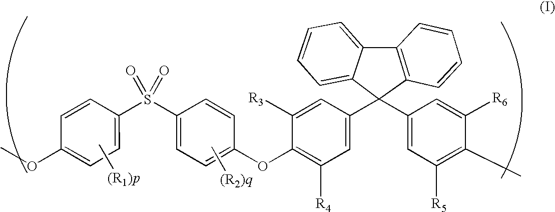
wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,
and a structural unit of the formula (II) 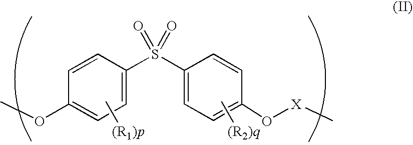
wherein R₁,R₂, p and q have the same meanings as described above, and X represents divalent group derived from alicyclic bisphenol.

2. The aromatic polysulfone resin according to claim 1 wherein the alicyclic bisphenol is at least one kind selected from the group consisting of
1,1,3-trimethyl-3-(4-hydroxyphenyl)-indane-5-ol,
3,3,3′,3′-tetramethyl-1,1′-spirobi[indane]-6,6′-diol,
1,3-dimethyl-1,3-(4-hydroxyphenyl)cyclohexane and
4,4′-[1-methyl-4-(1-methylethyl)-1,3-cyclohexanediyl]bisphenol.

3. The aromatic polysulfone resin according to claim 1 wherein reduced viscosity of the aromatic polysulfone resin is from 50 to 100 cm³/g.

4. A solution composition comprising an aromatic polysulfone resin comprising a structural unit of the formula (I) 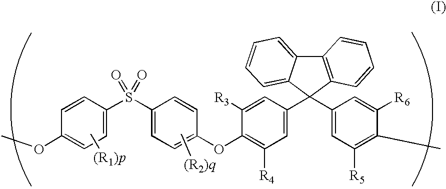
wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,
and a structural unit of the formula (II) 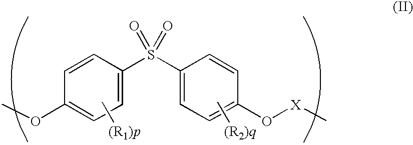
wherein R₁,R₂, p and q have the same meanings as described above, and X represents divalent group derived from alicyclic bisphenol; and a solvent.

5. The solution composition according to claim 4 wherein the content of the aromatic polysulfone resin is 10 to 50 parts by weight in 100 parts by weight of the solution composition.

6. The solution composition according to claim 4 wherein the solvent is at least one kind selected from the group consisting of an amide-based solvent and a ketone-based solvent.

7. A film comprising an aromatic polysulfone resin comprising a structural unit of the formula (I) 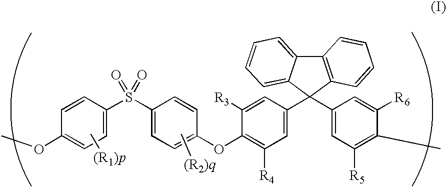
wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,
and a structural unit of the formula (II) 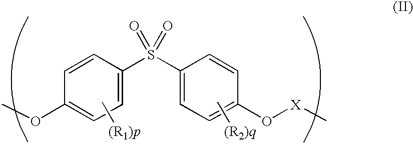
wherein R₁,R₂, p and q have the same meanings as described above, and X represents divalent group derived from alicyclic bisphenol.

8. The film according to claim 7 which is obtained by casting a solution composition comprising the aromatic polysulfone resin and a solvent and removing the solvent.

9. An enameled wire comprising a conductor and an aromatic polysulfone resin coating thereon which comprses a structural unit of the formula (I) 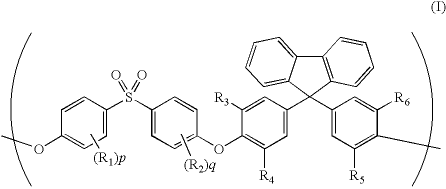
wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,
and a structural unit of the formula (II) 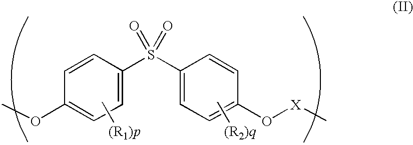
wherein R₁,R₂, p and q have the same meanings as described above, and X represents divalent group derived from alicyclic bisphenol.

10. The enameled wire according to claim 9 which is obtained by applying a solution composition comprising the aromatic polysulfone resin and a solvent on the conductor, and baking the solution composition applied conductor.

11. A plastic substrate comprising first layer which comprises an aromatic polysulfone resin which comprses a structural unit of the formula (I) 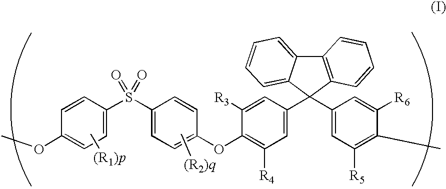
wherein R₁ and R₂ each independently represents halogen, alkyl having 1 to 6 carbon atoms, alkenyl having 2 to 10 carbon atoms, or phenyl, R₃ to R₆ each independently represents hydrogen, methyl, ethyl or phenyl, p and q represents an integer of 0 to 4,
and a structural unit of the formula (II) 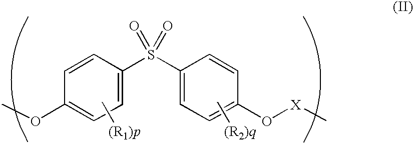
wherein R₁,R₂, p and q have the same meanings as described above, and X represents divalent group derived from alicyclic bisphenol; and second layer which comprises a material having lower glass transition temperature than that of the first layer and optically transparent and is laminated on the first layer.
